(19) United States
(12) Patent Application Publication
(10) Pub. No.: US 2018/0209596 A1
(43) Pub. Date: Jul. 26, 2018

(54) CLOAK-SHAPED NET MESH DECORATIVE LIGHTING STRING

(71) Applicant: George TSAI, Taipei (TW)

(72) Inventor: George TSAI, Taipei (TW)

(21) Appl. No.: 15/413,355

(22) Filed: Jan. 23, 2017

(51) Int. Cl. F21S 4/15

(52) U.S. Cl. CPC F21S 4/15; F21W 2121/04

(57) ABSTRACT

A cloak-shaped net mesh lighting string is in a state of being spread out on a plane and includes multiple first strings and multiple second strings. Each first string has a top end and a bottom end opposite to the top end, and the bottom ends of the first string are spaced apart from each other. The multiple second strings are spaced apart from each other and are tied to each first string to constitute the form of a net mesh. Each second string has multiple bulbs connected thereto and a resistor kit connected thereto and mounted next to one of the bulbs. At least one of the multiple first strings is an electrical wire for transmitting power to each second string. The remaining first strings are tied to the multiple second strings to keep each adjacent two of the multiple second strings to be spaced apart.

### BACKGROUND OF THE INVENTION

### 1. Field of the Invention

The present invention relates to a lighting string and, more particularly, to a cloak-shaped net mesh decorative lighting string.

### 2. Description of the Related Art

When consumers purchase pine, cypress or artificial trees for decorating their Christmas tree, they also need to purchase Christmas lighting strings to create a Christmas atmosphere.

There are a variety of forms of conventional Christmas lighting strings in the market, such as straight lights, curtain lights, rectangular net lights and the like. When decorating a Christmas tree, it is usually hard for consumers to evenly distribute bulbs of Christmas lighting strings over branches of the tree, and consequently, after the decoration is done, there is a chance that bulbs of the Christmas lighting strings are not fully used or are not enough for covering the entire tree. Under the circumstance, consumers need to take off the Christmas lighting strings and redecorate again. Repeatedly putting on and taking off the lighting strings is a labor-intensive and time-consuming job. Besides, as the Christmas lighting strings are manually and sequentially put on the Christmas tree, gaps between bulbs of the Christmas lighting strings are not uniformly arranged, leading to the Christmas tree being extraordinary bright at certain branches and leaves while dark at others without fully showing its ornamental effect.

### SUMMARY OF THE INVENTION

An objective of the present invention is to provide a cloak-shaped net mesh decorative lighting string with a sector shape capable of being decorated and hung on a Christmas tree in a fast and convenient way.

To achieve the foregoing objective, the cloak-shaped net mesh decorative lighting string is in a state of fully spread out on a plane and includes multiple first strings and multiple second strings.

Each first string has a top end and a bottom end opposite to the top end. The bottom ends of the multiple first strings are spaced apart from each other by gaps.

Each second string has multiple bulbs connected thereto and spaced apart from each other. Each adjacent two of the multiple second strings are spaced apart from each other and are intersected with and tied to each first string to constitute the form of a net mesh.

At least one of the multiple first strings is an electrical wire, and the remaining first strings are tied to the multiple second strings to keep each adjacent two of the multiple second strings to be spaced apart from each other. The multiple second strings are electrical wires and are connected to and receives power from the at least one first string that is the electrical wire.

The cloak-shaped net mesh decorative lighting string is advantageous in an easy and convenient installation for a Christmas tree decoration that after the top end of each first string is hung on a top of the Christmas tree, the lighting string can be wholly placed around the Christmas tree and the decoration can be done by minor adjustment of the lighting string as desired. Additionally, each second string has multiple bulbs spaced apart from each other ensuring the Christmas tree to be uniformly lit and aesthetic appealing.

Other objectives, advantages and novel features of the invention will become more apparent from the following detailed description when taken in conjunction with the accompanying drawings.

### BRIEF DESCRIPTION OF THE DRAWINGS

FIG. 1 is a top view of a first embodiment of a cloak-shaped net mesh decorative lighting string in a state of being spread out in accordance with the present invention;

FIG. 2 is a partially enlarged view of the cloak-shaped net mesh decorative lighting string in FIG. 1;

FIG. 3 is a top view of a second embodiment of a cloak-shaped net mesh decorative lighting string in a state of being spread out in accordance with the present invention;

FIG. 4 is a top view of a third embodiment of a cloak-shaped net mesh decorative lighting string in a state of being spread out in accordance with the present invention;

FIG. 5 is a schematic view of the cloak-shaped net mesh decorative lighting string in FIG. 1 when the lighting string is decorated on a Christmas tree;

FIG. 6 is a top view of a fourth embodiment of a cloak-shaped net mesh decorative lighting string in a state of being spread out in accordance with the present invention;

FIG. 7 is a top view of a fifth embodiment of a cloak-shaped net mesh decorative lighting string in a state of being spread out in accordance with the present invention;

FIG. 8 is a top view of a sixth embodiment of a cloak-shaped net mesh decorative lighting string in a state of being spread out in accordance with the present invention; and

FIG. 9 is a schematic view of the cloak-shaped net mesh decorative lighting string in FIG. 6 when the lighting string is decorated on a Christmas tree.

### DETAILED DESCRIPTION OF THE INVENTION

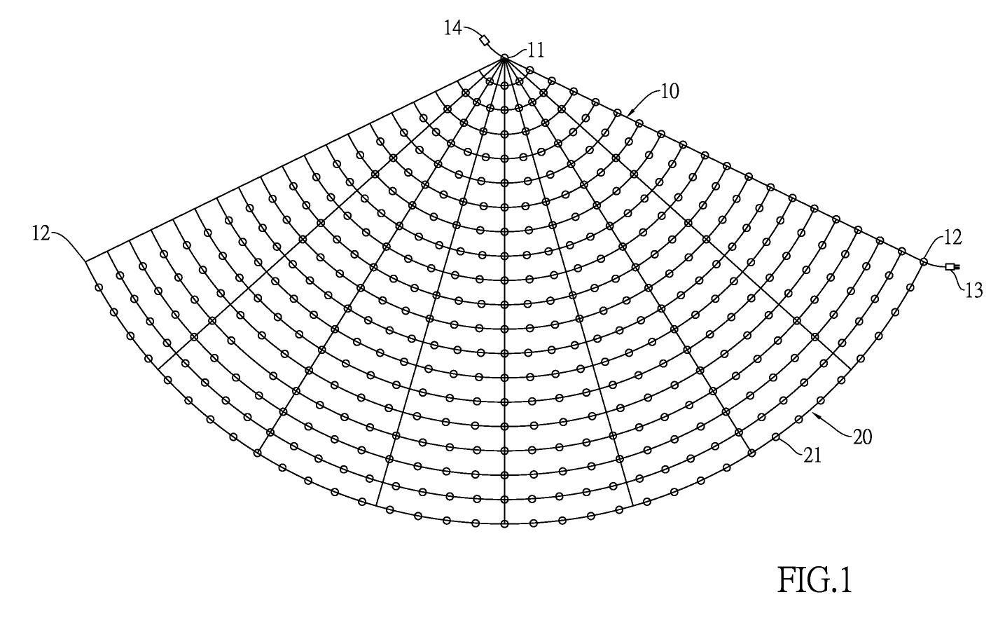

With reference to FIG. 1, a first embodiment of a cloak-shaped net mesh decorative lighting string in accordance with the present invention is in a state of being fully spread out on a plane and takes the form of a sector, and includes multiple first strings 10 and multiple second strings 20 with each second string 20 intersected with the multiple first strings 10.

Each first string 10 has a top end 11 and a bottom end 12 opposite to the top end 10. The top ends 11 of the multiple first strings 10 are commonly connected at a point and the bottom ends 12 of the multiple first strings 10 are spaced apart from each other by gaps for an area spread over the plane by the multiple first strings 10 to take the form of a sector. At least one of the multiple first strings 10 is an electrical cable. The remaining first strings 10 are not electrical wires and are tied to the multiple second strings 20 to keep each adjacent two of the multiple second strings 20 to be spaced apart from each other. Preferably, the first string 10 that is the electrical wire is not limited to be any of the two outermost first strings 10, two ends of the first string 10 that is the electrical wire have a power plug 13 and a power connector 14 respectively, and the first string 10 that is the electrical wire further has a controller 15 mounted next to the power plug 13.

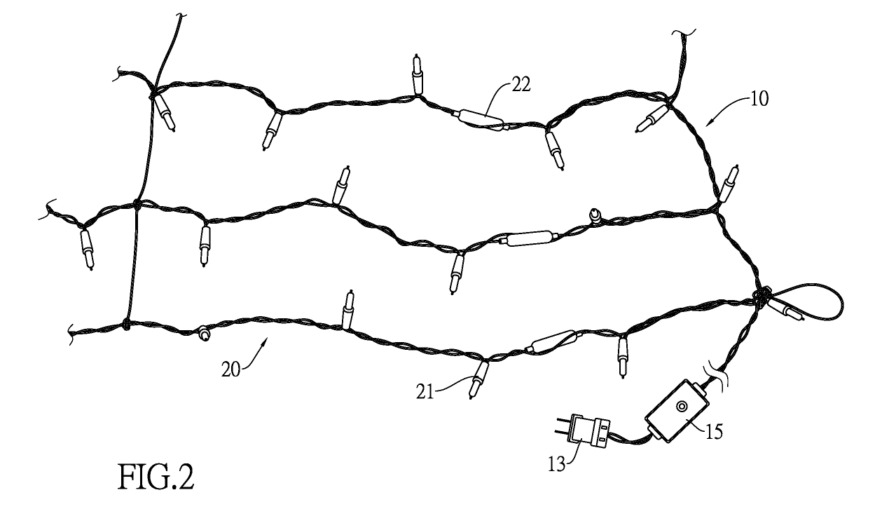

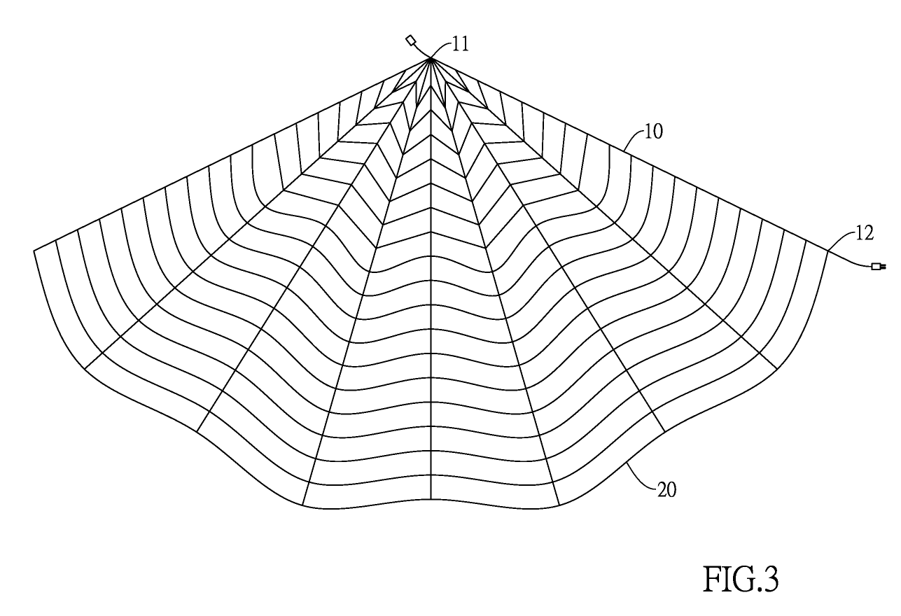

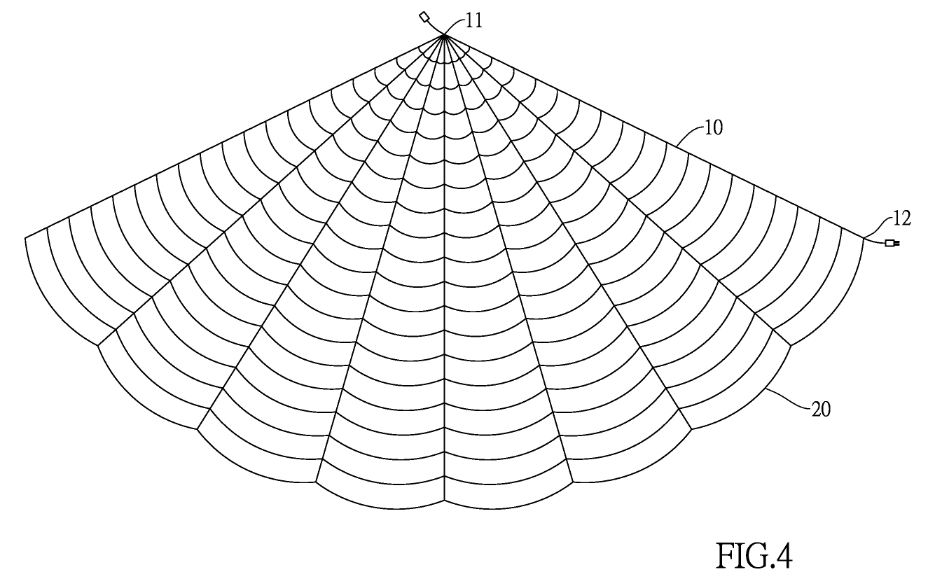

With reference to FIGS. 1 and 2, the multiple second strings 20 are electrical wires connected to the electrical wire and receiving power transmitted from the an electrical wire, and each adjacent two of the multiple second strings are spaced apart from each other and are intersected with and tied to each first string 10 to constitute the form of a net mesh. Each second string 20 has multiple bulbs 21 connected thereto and spaced apart from each other. Preferably, each bulb 21 on the second string 20 is an incandescent light bulb or a light-emitting diode (LED) light bulb, and the cloak-shaped net mesh decorative lighting string further includes multiple resistor kits 22 each of which is connected to one of the multiple second strings 20 and is mounted adjacent to one of the multiple bulbs 21 on the second string 20, or is mounted inside each bulb 21. With reference to FIG. 3, a second embodiment of a cloak-shaped net mesh decorative lighting string is in a state of being fully spread out on a plane and differs from the first embodiment in that each second string 20 takes a wavy form. With reference to FIG. 4, a third embodiment of a cloak-shaped net mesh decorative lighting string is in a state of being fully spread out on a plane and differs from the first embodiment in that a portion of each second string 20 between adjacent two of the multiple first strings 10 takes a curved form with a concave face of the portion facing the top end 11 of each first string 10.

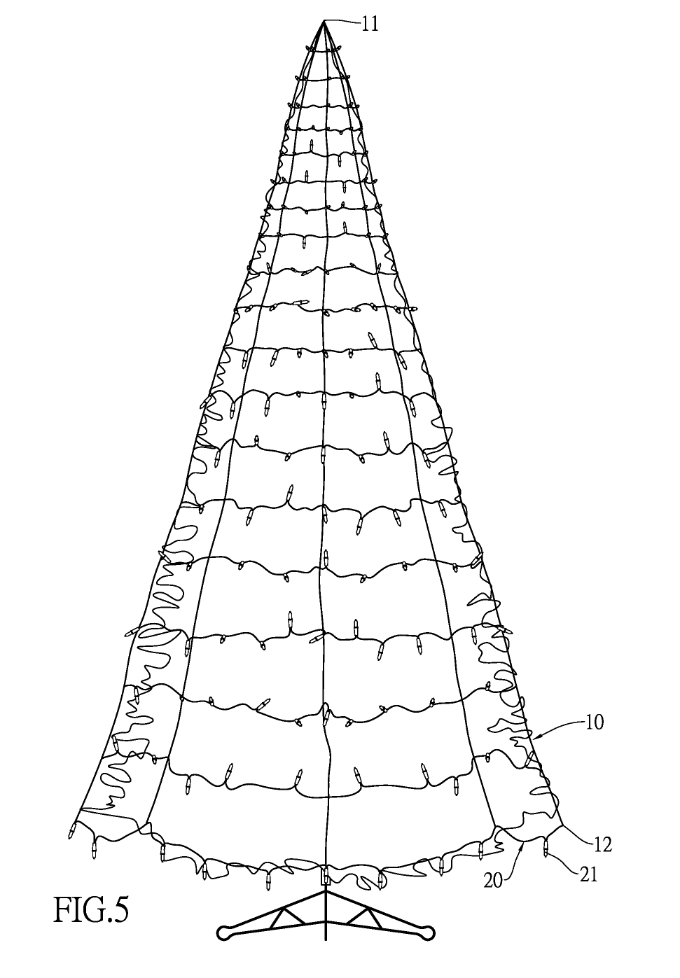

With reference to FIG. 5, when the cloak-shaped net mesh decorative lighting string in FIG. 1 is decorated on a Christmas tree, users can grab and put the lighting string on the Christmas tree with the top end 11 of each first end 10 rested on the top of the Christmas tree and the bottom ends 12 of the multiple first ends 10 wrapped around a bottom portion of the Christmas tree, such that initial work for hanging the lighting string on the Christmas tree can be roughly done. Minor adjustment of the first strings 10, the second strings 20 and the bulbs 21 might be needed to adjust decoration of the lighting string as desired by the users. As each adjacent two of the multiple second strings 20 are spaced apart and each second string 20 has multiple bulbs 21 evenly distributed around the Christmas tree to ensure the Christmas tree to be uniformly lit and aesthetic appealing.

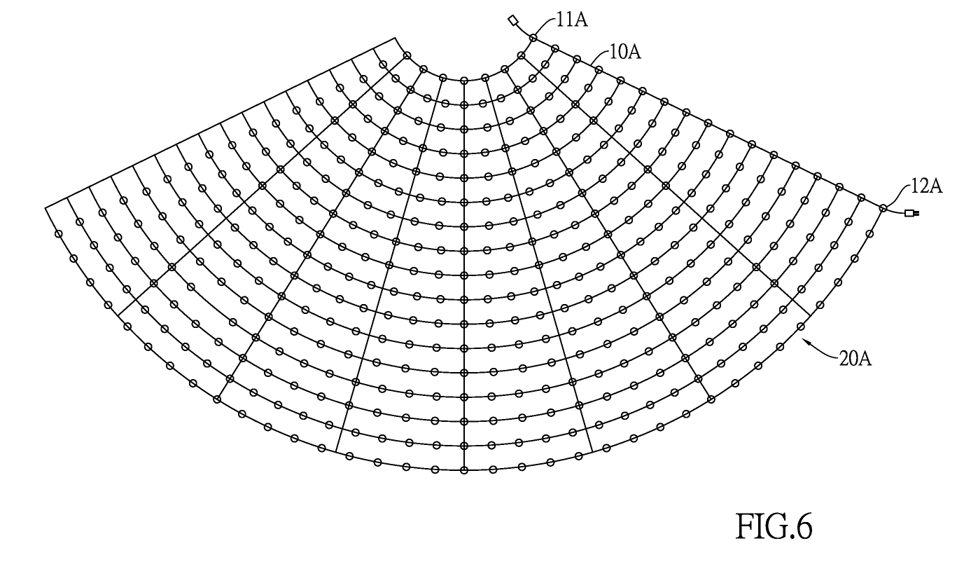

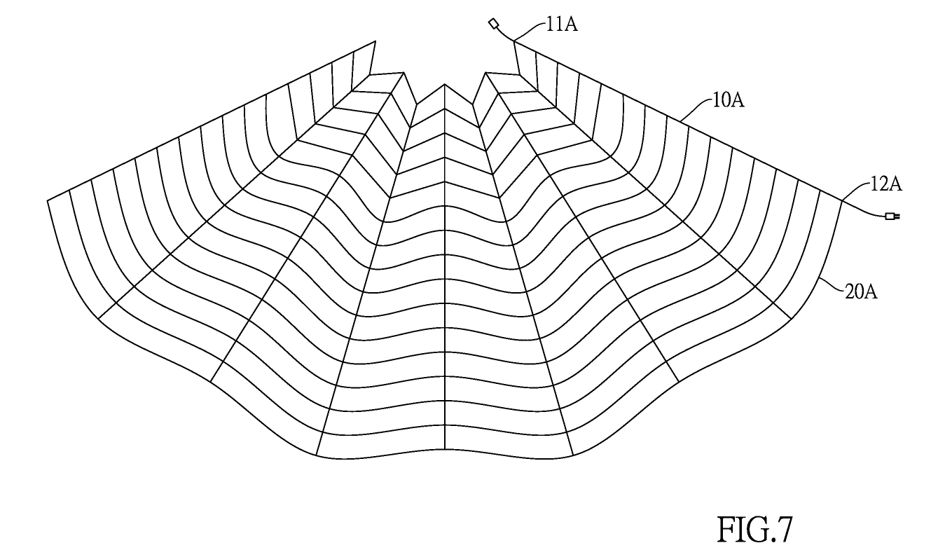

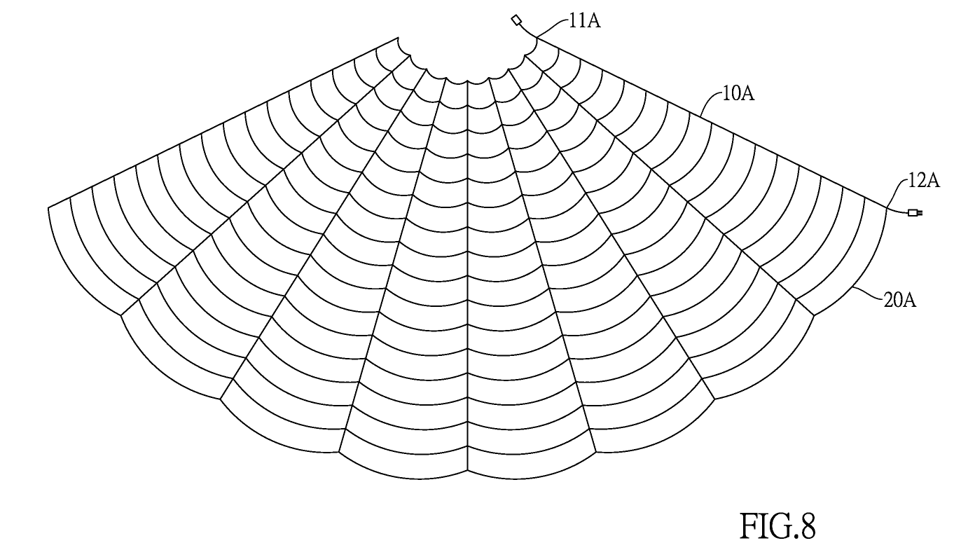

With reference to FIG. 6, a fourth embodiment of a cloak-shaped net mesh decorative lighting string in accordance with the present invention is in a state of being fully spread out on a plane and differs from the first embodiment in that the top ends 11A of the multiple first strings 10A are spaced apart from each other with one of the multiple second strings 20A tied to the top ends of the multiple first strings 10A, and an area spread over the plane by the multiple first strings 10A takes the form of a sector with a tip portion hollowed out. With reference to FIG. 7, a fifth embodiment of a cloak-shaped net mesh decorative lighting string in accordance with the present invention is in a state of being fully spread out on a plane and differs from the fourth embodiment in that each second string 20A takes a wavy form. With reference to FIG. 8, a sixth embodiment of a cloak-shaped net mesh decorative lighting string in accordance with the present invention is in a state of being fully spread out on a plane and differs from the fourth embodiment in that a portion of each second string 20A between adjacent two of the multiple first strings 10A takes a curved form with a concave face of the portion facing the top end 11A of each first string 10A.

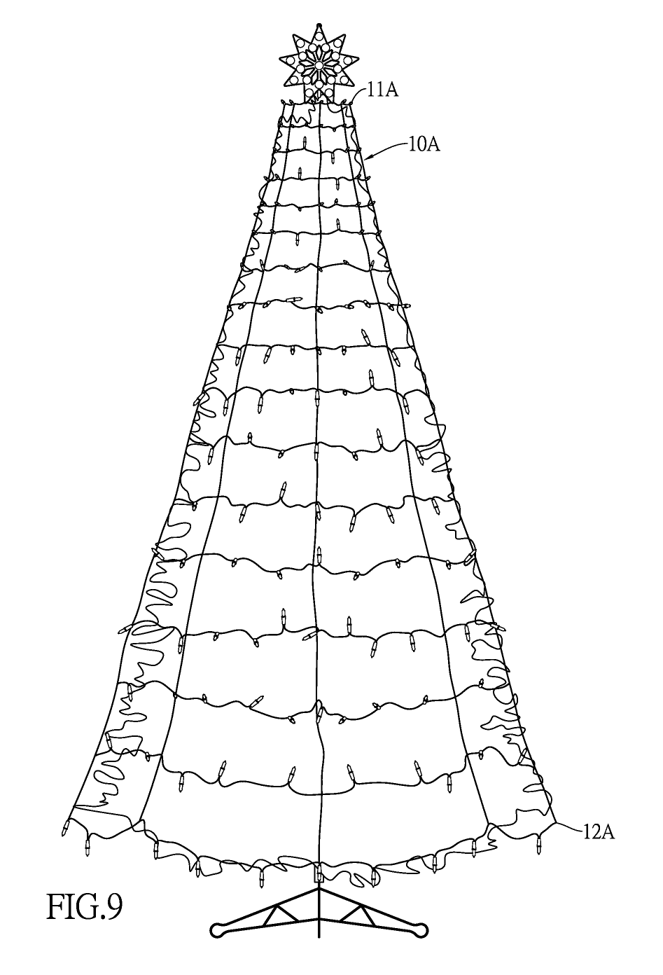

With reference to FIG. 9, when the cloak-shaped net mesh decorative lighting string in FIG. 6 is decorated on a Christmas tree, users can grab and put the lighting string on the Christmas tree with the top ends 11A of the multiple first ends 10A rested around a portion beneath the top of the Christmas tree and the bottom ends 12A of the multiple first ends 10A wrapped around a bottom portion of the Christmas tree, such that initial work for hanging the lighting string on the Christmas tree can be roughly done. Minor adjustment of the first strings 10, the second strings 20 and the bulbs 21 might be needed to adjust decoration of the lighting string as desired by the users.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A cloak-shaped net mesh decorative lighting string being in a state of fully spread out on a plane, comprising:
multiple first strings, each first string having a top end and a bottom end opposite to the top end, wherein the bottom ends of the multiple first strings are spaced apart from each other by gaps; and
each second string having multiple bulbs connected thereto and spaced apart from each other, wherein each adjacent two of the multiple second strings are spaced apart from each other and are intersected with and tied to each first string to constitute the form of a net mesh;
wherein at least one of the multiple first strings is an electrical wire and the remaining first strings are tied to the multiple second strings to keep each adjacent two of the multiple second strings to be spaced apart from each other, and the multiple second strings are electrical wires and are connected to and receives power from the at least one first string that is an electrical wire.

2. The cloak-shaped net mesh decorative lighting string as claimed in claim 1, wherein two ends of each one of the at least one first string have a power plug and a power connector respectively.

3. The cloak-shaped net mesh decorative lighting string as claimed in claim 2, wherein one of the at least one first string that is the electrical wire further has a controller mounted next to the power plug.

4. The cloak-shaped net mesh decorative lighting string as claimed in claim 1, further comprising multiple resistor kits, wherein each resistor kit is connected to one of the multiple second strings and is mounted adjacent to one of the multiple bulbs on the second string or is mounted inside each bulb.

5. The cloak-shaped net mesh decorative lighting string as claimed in claim 1, wherein each bulb is an incandescent light bulb or a light-emitting diode (LED) light bulb.

6. The cloak-shaped net mesh decorative lighting string as claimed in claim 1, wherein the top ends of the multiple first strings are commonly connected at a point and the bottom ends of the multiple first strings are spaced apart from each other by gaps for the multiple first strings to be distributed over the plane and take the form of a sector.

7. The cloak-shaped net mesh decorative lighting string as claimed in claim 1, wherein the top ends of the multiple first strings are spaced apart from each other with one of the multiple second strings tied to the top ends of the multiple first strings, and an area spread over the plane by the multiple first strings takes the form of a sector with a tip portion hollowed out.

8. The cloak-shaped net mesh decorative lighting string as claimed in claim 6, wherein a portion of each second string between adjacent two of the multiple first strings takes a curved form with a concave face of the portion facing the top end of each first string.

9. The cloak-shaped net mesh decorative lighting string as claimed in claim 7, wherein a portion of each second string between adjacent two of the multiple first strings takes a curved form with a concave face of the portion facing the top end of each first string.

10. The cloak-shaped net mesh decorative lighting string as claimed in claim 6, wherein each second string takes a wavy form.

11. The cloak-shaped net mesh decorative lighting string as claimed in claim 7, wherein each second string takes a wavy form.
